(19) United States
(12) Patent Application Publication
(10) Pub. No.: US 2015/0058087 A1
(43) Pub. Date: Feb. 26, 2015

(54) METHOD OF IDENTIFYING SIMILAR STORES

(71) Applicant: International Business Machines Corporation, Armonk, NY (US)

(72) Inventors: Dmitry A. Kulagin, Moscow (RU); Oleg Sidorkin, Tiroal (AT); Egor Zakharov, Moscow (RU); Pavel Zelinsky, Boulder, CO (US)

(73) Assignee: International Business Machines Corporation, Armonk, NY (US)

(21) Appl. No.: 13/971,137

(22) Filed: Aug. 20, 2013

(51) Int. Cl. G06Q 30/02

(52) U.S. Cl. CPC G06Q 30/0204; G06Q 30/0205
USPC 705/7.34; 705/7.33

(57) ABSTRACT

A computer-implemented method and computer program product for identifying similar stores and determining store parameters based on the similar stores. The one or more computer programs identify key items by selecting a subset of all items. The one or more computer programs assign store feature vectors each including values of a store behavior for the key items. The one or more computer programs determine a similarity distance between each pair of the vectors. The one or more computer programs identify similar stores of a given store based on the similarity distance. The one or more computer programs determine one or more parameters for the given stores, based on the similar stores.

### FIELD OF THE INVENTION

The present invention relates generally to a computer-implemented method for analyzing data of retail stores, and more particularly to a computer-implemented method for identifying similar stores.

### BACKGROUND

Slow moving goods such as fashion apparel often have very sparse sales. It becomes a problem when one needs to model or forecast demand at an item/store level. A common approach is to borrow information from other stores. However, the other stores have generally different behaviors. While the information of the other stores is used, it must be sure that the other stores are, in some ways, similar to the store. Therefore, similar stores should be identified. The similar stores are typically identified through using store attributes such as geographic locations, climate zones, and population types. This approach to identify the similar stores using the store attributes is not robust enough because of the following reasons. The store attributes can only provide information of averaging all items or categories in each of the similar stores but do not provide enough information at item or category levels. Typically, the similar stores have a very limited number of the store attributes and frequently do not well maintain information of the store attributes. The store attributes are indirect indicators of store similarity.

### BRIEF SUMMARY

Embodiments of the present invention provide a computer-implemented method and a computer program product for identifying similar stores and determining store parameters based on the similar stores. One or more computer programs identify key items for a plurality of stores. The one or more computer programs assign feature vectors to respective ones of the plurality of stores, each of the feature vectors comprising values of a behavior for the key items. The one or more computer programs determine a similarity distance between each pair of the vectors. The one or more computer programs identify similar stores of a respective one of the plurality of stores, based on the similarity distance. The one or more computer programs determine one or more parameters for a respective one of the plurality of stores, based on the similar stores.

### BRIEF DESCRIPTION OF THE SEVERAL VIEWS OF THE DRAWINGS

FIG. 1 is a flowchart illustrating operational steps for identifying similar stores and determining store parameters based on the similar stores, in accordance with an exemplary embodiment of the present invention.

FIG. 2 is a flowchart illustrating operational steps for determining key items in stores, in accordance with an exemplary embodiment of the present invention.

FIG. 3 is a flowchart illustrating operational steps for determining similar stores, in accordance with an exemplary embodiment of the present invention.

FIG. 4 is a diagram illustrating components of a computing device hosting one or more programs implementing the operational steps shown in FIGS. 1, 2, and 3, in accordance with an exemplary embodiment of the present invention.

### DETAILED DESCRIPTION

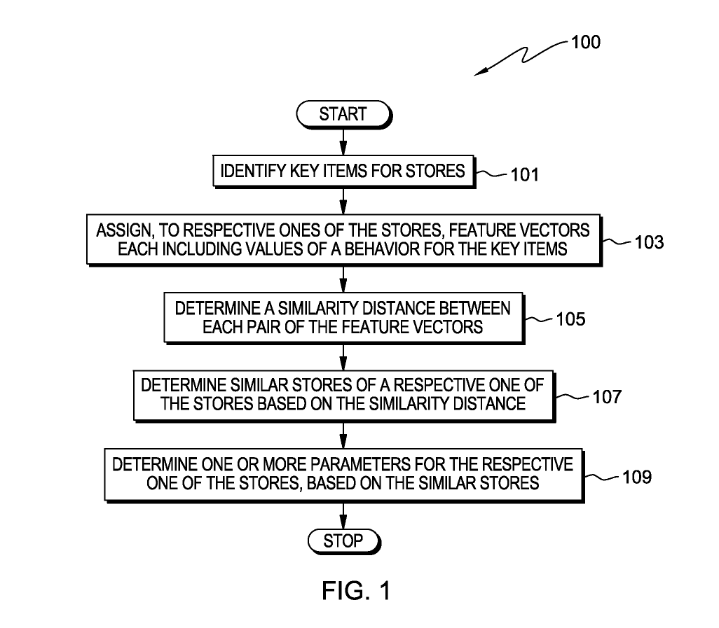

FIG. 1 is flowchart 100 illustrating operational steps for identifying similar stores and determining store parameters based on the similar stores, in accordance with an exemplary embodiment of the present invention. The operational steps are implemented by one or more computer programs.

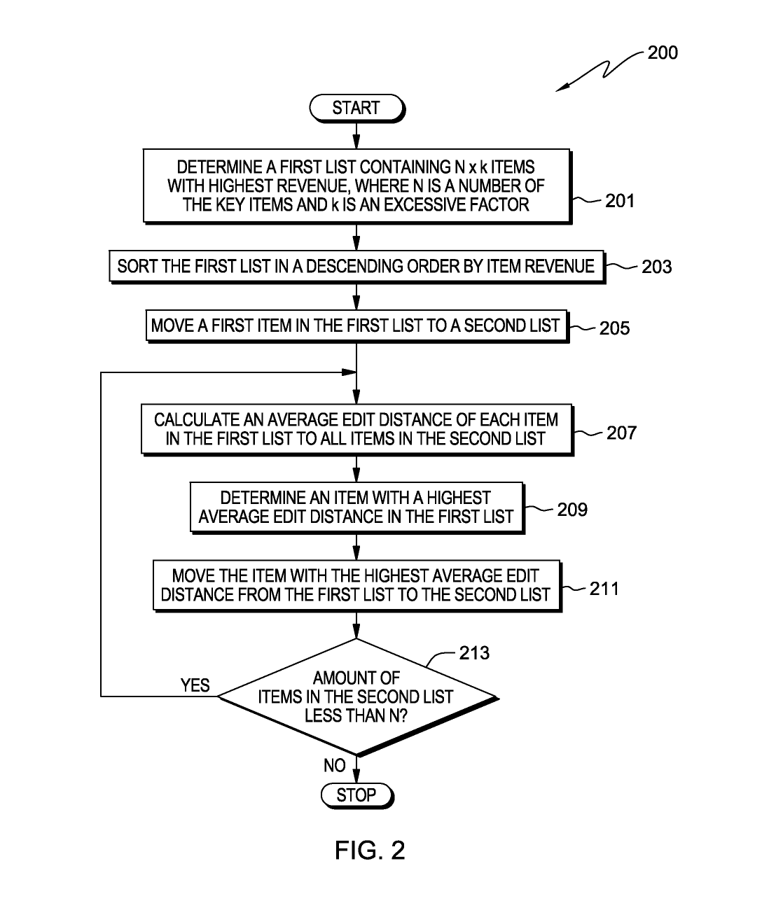

Referring to FIG. 1, at step 101, the one or more computer programs identify key items of a plurality of stores. Operational steps for identifying the key items are discussed in detail in later paragraphs of this document, with reference to FIG. 2. This step is based on an idea that there is no need to analyze a behavior in all items in order to measure store similarity. It is often the case that there exists only very limited number (e.g., from 5 to 10) of items which capture major differences in the behavior of the plurality of stores. Therefore, in the exemplary embodiment, the one or more computer programs identify key items by selecting a subset of the all items. Items in this subset are the key items. Identifying the key items significantly reduces the dimensionality of the problem and thus significantly simplifies problems in the following steps for finding similar stores and determining store parameters based on the behavior of the similar stores.

Referring to FIG. 1, at step 103, the one or more computer programs assign feature vectors to respective ones of the plurality of stores. Each of the feature vectors includes values of the behavior for the key items. A respective one of the feature vectors represents the behavior of a respective one of the plurality of stores. In the exemplary embodiment, the average weekly sell-through is used as the behavior. In the exemplary embodiment, the vectors are defined as:

\vec{Behavior}ₛₜₒᵣₑ_{_{—}}ᵢ={SellThroughₛₜₒᵣₑ_{_{—}}_{i,key}_{_{—}}ᵢₜₑₘ_{_{—}}ⱼ}

where \vec{Behavior}ₛₜₒᵣₑ_{_{—}}ᵢ is a feature vector for i-th store, SellThroughₛₜₒᵣₑ_{_{—}}_{i, key}_{_{—}}ᵢₜₑₘ_{_{—}}ⱼ is the average weekly sell-through for j-th key item at i-th store. Each of the plurality of stores has one of the feature vectors. The dimension for each of the feature vectors is N which is the total number of the key items. In the exemplary embodiment, to make weights of different key items equal, normalization can be applied to the feature vectors.

Referring to FIG. 1, at step 105, the one or more computer programs determine a similarity distance between each pair of the feature vectors. In the exemplary embodiment, to determine the similarity distance, the one or more computers calculate a Euclidian distance between each pair of the feature vectors. The Euclidian distance between the each pair of the feature vectors is used as a measurement of store similarity among the plurality of stores.

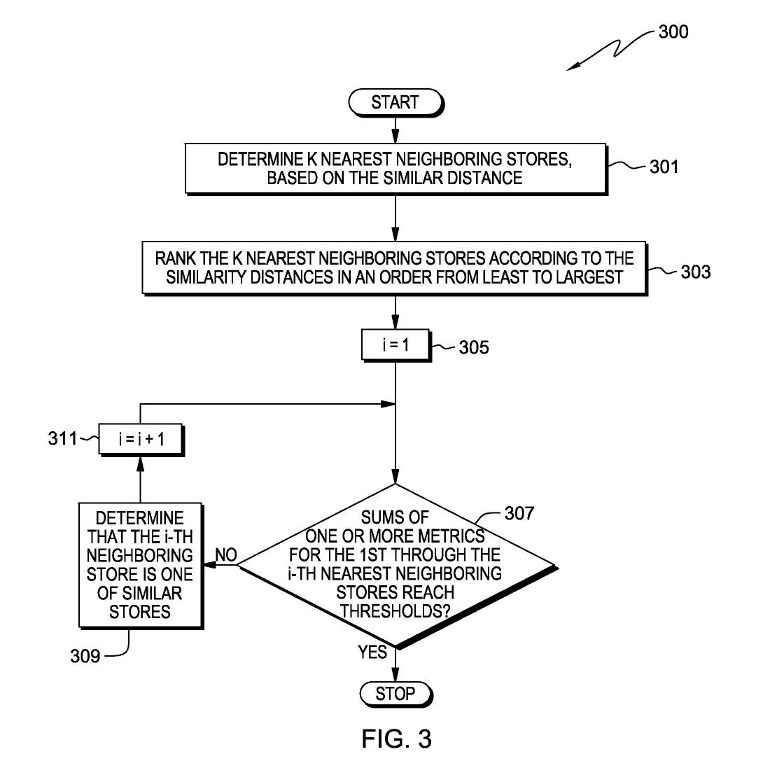

Referring to FIG. 1, the one or more computer programs, at step 107, determine similar stores of a respective one of the plurality of stores. To determine the similar stores, the one or more computers select a subset of the plurality of stores. Operational steps for determining the similar stores are discussed in detail in later paragraphs of this document, with reference to FIG. 3.

Referring to FIG. 1, the one or more computer programs, at step 109, determine one or more parameters for the respective one of the plurality of stores, based on the similar stores. The one or more parameters include, for example, price elasticity, seasonality, demand at regular price, maximum demand potential, and other parameters for modeling. For determining a respective one of the one or more parameters, either of following two methods is used. (1) In the first method, it is assumed that parameter values of respective ones of the similar stores are known. The first method is to average the parameter values of the respective ones of the similar stores, with weights for the respective ones of the similar stores. Each of the weights is a multiplicative inverse of the similarity distance. (2) In the second method, parameter values of respective ones of the similar stores are unknown. The one or more computer programs combine datasets of the similar stores and run a parameter estimation algorithm, such as linear regression, on a combined dataset of the similar stores.

FIG. 2 is flowchart 200 illustrating operational steps for determining key items in stores, in accordance with an exemplary embodiment of the present invention. The operational steps in FIG. 2 are exemplary implementation of step 101 shown in FIG. 1. The operational steps are implemented by one or more computer programs.

There are potentially many ways to select the key items. Currently, an implemented approach is to choose a fixed number of items with the highest revenue in the last year. The rationale of this approach is that these items are most influential within a category, and high sales provide some confidence that most stores have sales. Selecting the key items based on only revenue has one potential problem; it may select similar items as the key items, for example, the same product but different sizes or colors. The approach is undesirable, because the similar items have strongly correlated behaviors in a majority of stores. These similar items as the key items should be avoided; therefore, it is desirable to have only one such item as a key item.

As an example, ten items with highest revenue selected from some swimwear categories are listed in Table 1. In Table 1, there exist some similar items. In Table 1, two items of ranks 1 and 2 are actually the same product with different sizes (M and S). In Table 1, items of swim shark panama (rank 4) and swim bubble panama (rank 6) are two similar items which are just different in style.

TABLE 1

| Rank | Revenue | Description |
|---|---|---|
| 1 | $20728 | SWIM 3D SKULLS M |
| 2 | $20682 | SWIM 3D SKULLS S |
| 3 | $20534 | SWIM SHIRT TRUE WHITE L |
| 4 | $19886 | SWIM SHARK PANAMA M |
| 5 | $19228 | SWIM GLASS HURRICANE M |
| 6 | $18933 | SWIM BUBBLE PANAMA M |
| 7 | $18666 | SWIM SUPERSTAR M |
| 8 | $17895 | SWIM SUPERSTAR S |
| 9 | $17507 | RASHGRD EBONY L |
| 10 | $16964 | SWIM SHIRT WHITE XL |

Referring to FIG. 2, at step 201, the one or more computer programs determine a first list containing N×k items with highest revenue, where N is the number of the key items which are to be found and k is an excessive factor. As an example, for N=3 and k=2, the one or more computer programs determine 3×2 items in the first list. The 6 items are selected from the items in Table 1. At step 203, the one or more computer programs sort the first list in a descending order based on item revenue. The first list of the example is presented in Table 2.

TABLE 2

| Rank | Description |
|---|---|
| 1 | SWIM 3D SKULLS M |
| 2 | SWIM 3D SKULLS S |
| 3 | SWIM SHIRT TRUE WHITE L |
| 4 | SWIM SHARK PANAMA M |
| 5 | SWIM GLASS HURRICANE M |
| 6 | SWIM BUBBLE PANAMA M |

Referring to FIG. 2, at step 205, the one or more computer programs move a first item in the first list to a second list. For the same example, the result of this step is shown in Table 3. In Table 3, the first and the second list are respectively presented in the left and the right columns.

TABLE 3

| First List | | Second List | |
|---|---|---|---|
| Rank | Description | Rank | Description |
| 2 | SWIM 3D SKULLS S | 1 | SWIM 3D SKULLS M |
| 3 | SWIM SHIRT TRUE WHITE L | | |
| 4 | SWIM SHARK PANAMA M | | |
| 5 | SWIM GLASS | | |
| | HURRICANE M | | |
| 6 | SWIM BUBBLE PANAMA M | | |

Referring to FIG. 2, at step 207, the one or more computer programs calculate an average edit (or Levenshtein) distance of each item in the first list to all items in the second list. In the exemplary embodiment, to measure similarity between descriptions of the items, the edit distance or Levenshtein distance is used. In information theory and computer science, the edit or Levenshtein distance is a string metric for measuring the difference between two sequences. The edit or Levenshtein distance between two words is the minimum number of single-character edits (insertion, deletion, substitution) required to change one word into the other. In the exemplary embodiment, a modification to the standard algorithm of the edit or Levenshtein distance is made. The modification is that no penalty is applied if descriptions of the items have different string lengths.

Referring to FIG. 2, at step 209, the one or more computer programs determine an item with the highest average edit (or Levenshtein) distance in the first list. At step 211, the one or more computer programs move the item with the highest average edit (or Levenshtein) distance from the first list to the second list. The item with highest average edit (or Levenshtein) distance is the most dissimilar to all items in the second list. In the same example, the one or more computer programs determine that the item of rank 3 is the one having the highest average edit (or Levenshtein) distance, and therefore the one or more computer programs move the item of rank 3 to the second list. The result is shown in Table 4, in which the first and the second list are respectively presented in the left and the right columns.

TABLE 4

| First List | | Second List | |
|---|---|---|---|
| Rank | Description | Rank | Description |
| 2 | SWIM 3D SKULLS S | 1 | SWIM 3D SKULLS M |
| 4 | SWIM SHARK PANAMA M | 3 | SWIM SHIRT TRUE |
| | | | WHITE L |
| 5 | SWIM GLASS | | |
| | HURRICANE M | | |
| 6 | SWIM BUBBLE PANAMA M | | |

Referring to FIG. 2, the one or more computer programs, at decision block 213, determine whether the items in the second list is less than N. In response to determining that the items in the second list is not less than N (NO branch of decision block 213), the one or more computer programs finish the determination of the N key items. In response to determining that the items in the second list is less than N (YES branch of decision block 213), the one or more computer programs reiterate steps 207, 209, 211, and 213, until all the N key items are determined. In the same example, because the number of the key items in Table 4 is less than N, which is 3, the one or more computer programs reiterate steps 207, 209, and 211. Within these steps, the one or more computer programs determine that the item of rank 4 is the one having the highest average edit (or Levenshtein) distance, and then moves the item of rank 4 to the second list. At decision block 213, the one or more computer programs determine that the key items in the second list is not less than N (which is 3), and thus finish the determination of the key items. For the same example, the 3 key items are presented in the column of the second list in Table 5.

TABLE 5

| First List | | Second List | |
|---|---|---|---|
| Rank | Description | Rank | Description |
| 2 | SWIM 3D SKULLS S | 1 | SWIM 3D SKULLS M |
| 5 | SWIM GLASS | 3 | SWIM SHIRT TRUE |
| | HURRICANE M | | WHITE L |
| 6 | SWIM BUBBLE | 4 | SWIM SHARK |
| | PANAMA M | | PANAMA M |

FIG. 3 is flowchart 300 illustrating operational steps for determining similar stores, in accordance with an exemplary embodiment of the present invention. The operational steps in FIG. 3 are exemplary implementation of step 107 shown in FIG. 1. The operational steps are implemented by one or more computer programs.

Referring to FIG. 3, at step 301, the one or more computer programs determine K nearest neighboring stores, based on the similarity distance which is determined at step 105 shown in FIG. 1. The number K is predetermined so that the K stores are chosen from the plurality of stores and further the similar stores can be chosen from the K stores. The number K is selected reasonably large to produce an excessive list for choosing the similar stores. There are several algorithms for this step. One of the algorithms is the k-nearest neighbor algorithm (k-NN), which is a non-parametric method for classifying objects based on closest training examples in the feature space. The k-nearest neighbor algorithm (k-NN) guarantees to find the nearest neighboring stores. The k-nearest neighbor algorithm (k-NN) has approximately complexity of O(n²), where n is the number of the stores. Another one of the algorithms is fast approximate nearest-neighbor search with k-nearest neighbor graph, which may be used at the cost of losing some percent of the nearest neighboring stores. At step 303, the one or more computer programs rank the K nearest neighboring stores according to the similarity distances, in an order from least to largest.

Referring to FIG. 3, at step 305, the one or more computer programs set i equal to 1. At decision block 307, the one or more computer programs determine whether sums of respective one or more metrics for the first through the i-th nearest neighboring stores, which are calculated based on combined datasets, reach predetermined respective thresholds. In the exemplary embodiment, the one or more metrics include, for example, inventory, units sold for each item, units sold for all items, total monetary quantity of sales for each item, and total monetary quantity of sales for all items. For example, the one or more computer programs determine whether the sum of the inventory for the first through the i-th stores reaches a predetermined threshold (a required minimum inventory).

Referring to FIG. 3, in response to determining that sums of respective one or more metrics for the first through the i-th nearest neighboring stores do not reach predetermined respective thresholds (NO branch of decision block 307), the one or more computer programs determine at step 309 that the i-th store is one of the similar stores, set i=i+1 at step 311, and reiterate decision block 307. In response to determine that sums of respective one or more metrics for the first through the i-th nearest neighboring stores reach predetermined respective thresholds (YES branch of decision block 307), the one or more computer programs stops searching the similar stores. Through the steps, the one or more computer programs determine a subset of the K nearest neighboring stores as similar stores. The quantity of the similar stores is less than or equal to K.

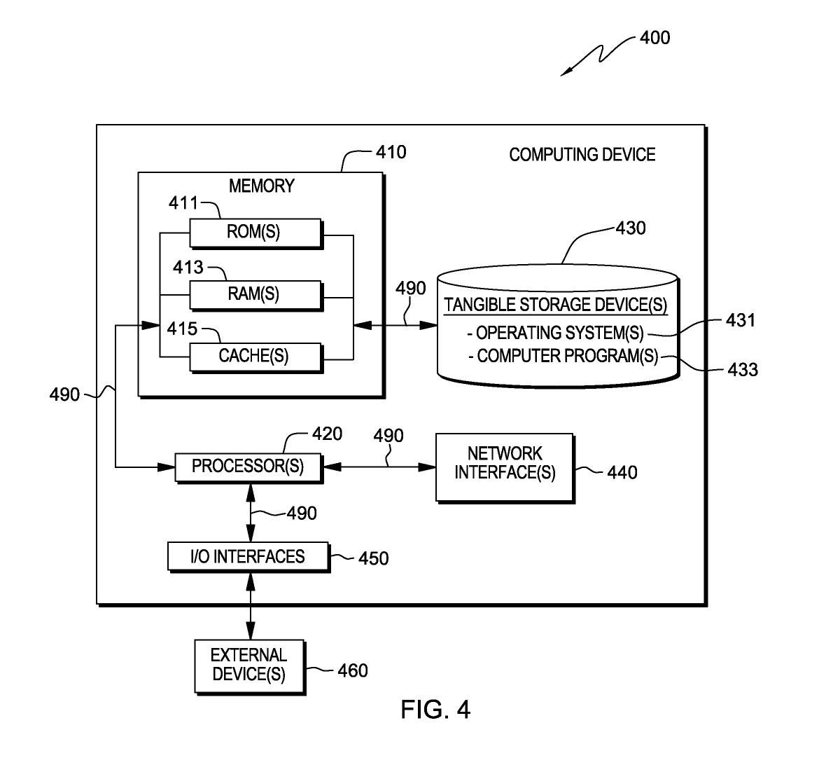

FIG. 4 is a diagram illustrating components of computing device 400 hosting one or more programs implementing the operational steps shown in FIGS. 1, 2, and 3, in accordance with an exemplary embodiment of the present invention. It should be appreciated that FIG. 4 provides only an illustration of one implementation and does not imply any limitations with regard to the environment in which different embodiments may be implemented. In other embodiments, the one or more programs may reside on respectively on multiple computer devices.

Referring to FIG. 4, computing device 400 includes processor(s) 420, memory 410, tangible storage device(s) 430, network interface(s) 440, and I/O (input/output) interface(s) 450. In FIG. 4, communications among the above-mentioned components of computing device 400 are denoted by numeral 490. Memory 410 includes ROM(s) (Read Only Memory) 411, RAM(s) (Random Access Memory) 413, and cache(s) 415.

One or more operating systems 431 and one or more computer programs 433 reside on one or more computer-readable tangible storage device(s) 430. In the exemplary embodiment, the one or more programs reside on one or more computer-readable tangible storage device(s) 430.

Computing device 400 further includes I/O interface(s) 450. I/O interface(s) 450 allow for input and output of data with external device(s) 460 that may be connected to computing device 400. Computing device 400 further includes network interface(s) 440 for communications between computing device 400 and a computer network.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, and micro-code), or an embodiment combining software and hardware aspects that may all generally be referred to herein as a “circuit,” “module”, or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF (radio frequency), and any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for identifying similar stores and determining item or store parameters based on the similar stores, the method comprising:
identifying key items for a plurality of stores;
assigning feature vectors to respective ones of the plurality of stores, each of the feature vectors comprising values of a behavior for the key items;
determining a similarity distance between each pair of the vectors;
identifying similar stores of a respective one of the plurality of stores, based on the similarity distance; and
determining one or more parameters for a respective one of the respective one of the plurality of stores, based on the similar stores.

2. The computer-implemented method of claim 1, wherein the behavior is average weekly sell-through.

3. The computer-implemented method of claim 1, wherein the similarity distance is an Euclidian distance between each pairs of the feature vectors.

4. The computer-implemented method of claim 1, wherein the one or more parameters include price elasticity, seasonality, demand at regular price, maximum demand potential, and other parameters for modeling.

5. The computer-implemented method of claim 1, further comprising steps of identifying the key items:
determining items with highest values of revenue;
calculating a string metric for measuring a difference between each pair of descriptions of the items; and
selecting the key items from the items, based on the string metric.

6. The computer-implemented method of claim 5, wherein the string metric is an edit distance or Levenshtein distance.

7. The computer-implemented method of claim 1, further comprising steps of determining the similar stores:
determining a predetermined number of nearest neighboring stores, based on the similarity distance;
determining whether sums of respective one or more metrics for a subset of the nearest neighboring stores reach predetermined respective thresholds; and
determining that stores in the subset are the similar stores, in response to determining that sums of respective one or more metrics for a subset of the nearest neighboring stores reach predetermined respective thresholds.

8. The computer-implemented method of claim 7, wherein the one or more metrics include inventory, a quantity of units sold, and a total monetary quantity of sales.

9. The computer-implemented method of claim 1, further comprising steps of determining a respective one of the one or more parameters:
averaging parameter values of respective ones of the similar stores; and
wherein weights for the respective ones of the similar stores are used and each of the weights is a multiplicative inverse of the similarity distance.

10. The computer-implemented method of claim 1, further comprising steps of determining a respective one of the one or more parameters:
combining datasets of respective ones of the similar stores; and
running a parameter estimate algorithm on a combined dataset of the similar stores.

11. A computer program product for identifying similar stores and determining item or store parameters based on the similar stores, the computer program product comprising a computer readable storage medium having program code embodied therewith, the program code executable to:
identify key items for a plurality of stores;
assign feature vectors to respective ones of the plurality of stores, each of the feature vectors comprising values of a behavior for the key items;
determine a similarity distance between each pair of the vectors;
identify similar stores of a respective one of the plurality of stores, based on the similarity distance; and
determine one or more parameters for a respective one of the respective one of the plurality of stores, based on the similar stores.

12. The computer program product of claim 11, wherein the behavior is average weekly sell-through.

13. The computer program product of claim 11, wherein the similarity distance is an Euclidian distance between each pairs of the feature vectors.

14. The computer program product of claim 11, wherein the one or more parameters include price elasticity, seasonality, demand at regular price, maximum demand potential, and other parameters for modeling.

15. The computer program product of claim 11, further comprising the program code for identifying the key items, the program code executable to:
determine items with highest values of revenue;
calculate a string metric for measuring a difference between each pair of descriptions of the items; and
select the key items from the items, based on the string metric.

16. The computer program product of claim 15, wherein the string metric is an edit distance or Levenshtein distance.

17. The computer program product of claim 11, further comprising the program code for determining the similar stores, the program code executable to:
determine a predetermined number of nearest neighboring stores, based on the similarity distance;
determine whether sums of respective one or more metrics for a subset of the nearest neighboring stores reach predetermined respective thresholds; and
determine that stores in the subset are the similar stores, in response to determining that sums of respective one or more metrics for a subset of the nearest neighboring stores reach predetermined respective thresholds.

18. The computer program product of claim 17, wherein the one or more metrics include inventory, a quantity of units sold, and a total monetary quantity of sales.

19. The computer program product of claim 11, further comprising the program code for determining a respective one of the one or more parameters, the program code executable to:
average parameter values of respective ones of the similar stores; and
wherein weights for the respective ones of the similar stores are used and each of the weights is a multiplicative inverse of the similarity distance.

20. The computer program product of claim 11, further comprising the program code for determining a respective one of the one or more parameters, the program code executable to:
combine datasets of respective ones of the similar stores; and
run a parameter estimate algorithm on a combined dataset of the similar stores.
